(19) United States
(12) Patent Application Publication
(10) Pub. No.: US 2008/0189895 A1
(43) Pub. Date: Aug. 14, 2008

(54) Device For Driving a Wiper Blade, Particularly For a Motor Vehicle

(75) Inventors: Severin Bruneau, Rambouillet (FR); Franck Macaire, Antony (FR); Yun Tang, Cernay La Ville (FR)

Correspondence Address: OSHA LIANG L.L.P., 1221 MCKINNEY STREET, SUITE 2800, HOUSTON, TX, 77010, US

(73) Assignee: Valeo Systemes d'Essuyage, Le Mesnil-Saint-Denis (FR)

(21) Appl. No.: 11/886,209

(22) PCT Filed: Mar. 24, 2006
(86) PCT No.: PCT/EP06/02722

§ 371 Date: Apr. 8, 2008

(30) Foreign Application Priority Data
Mar. 25, 2005 (FR) 0503000

(51) Int. Cl. B60S 1/24

(52) U.S. Cl. 15/250.31

(57) ABSTRACT

The invention relates to a device for driving a windshield wiper arm of a motor vehicle. The inventive device comprises a first motive part (1) which is solidly connected to a support piece (10) which is in turn fixed to the body of the vehicle, said first part driving a second part (2) comprising a drive shaft (23) for driving the windshield wiper arm. The aforementioned second part is fixed to a bearing (20) that is solidly connected to an element that can move in relation to the body, in particular a rear window. In addition, the device is associated with a mounting part, known as a wedge mount (3), which provides a temporary link between the above-mentioned first and second parts, such that said parts are positioned correctly in relation to one another. According to the invention, the wedge is solidly connected to the first part or the second part (1, 2) by means of detachable tongue elements (30).

The invention relates to a device for driving a windscreen-wiper blade, particularly for a motor vehicle.

More specifically, it relates to a device for driving a motor vehicle windscreen-wiper arm, comprising a first motive part solidly attached to a support piece fixed to the body of the vehicle, driving a second part comprising a drive shaft for driving the windscreen-wiper arm, this second part being fixed to a bearing solidly attached to an element mobile in relation to the body, in particular a rear window, this device being associated with a mounting part, known as a wedge mount, temporarily linking said first and second parts so as to ensure the correct relative position of said parts.

This solution with two disconnecting shaft parts, one being the motor output and the other driving the windscreen-wiper arm, is often used for equipping rear windows or rear hatches, since it represents a compromise between cost and safety.

These two shaft parts must be precisely positioned in relation to on another, mainly so as to ensure the synchronized movement of the motor and the arm.

Conventionally, the first part comprises a motor, the shaft of which drives the rotation of a plate, the motor and the plate being solidly attached to said support piece, the plate being designed to drive a ratchet finger of a crank driving a driving shaft of the windscreen-wiper arm comprised in the second part. The plate can be plastic or metallic and it is mounted on the output shaft of the motor. Its purpose is to drive the drive shaft of the arm by means of a ratchet finger mounted in an oblong hole in this plate. An arrangement of this type is described in patent application US 2004/0255424.

It is known to use a wedge mount temporarily linking the first and second parts during the assembly of the driving device. This wedge mount has two functions, namely to ensure coaxiality between the bearing shaft and the motor shaft and to ensure that the fixed stop of the bearing shaft is aligned with the fixed stop of the wiping motor, the fixed stop being the position of the blade on the glass when the motor is stopped.

It is known to use a wedge mount constituting a separate piece that can be used only once or several times. In the case of the wedge mount being reusable, its return to the supplier must be arranged after the wiping motor has been assembled on the vehicle assembly line.

The assembly process can be broken down as follows:

a) the operator mounts the bearing equipped with the wedge mount and the motor on the rear hatch;

b) he/she fixes the motor to the support piece solidly attached to the body;

c) he/she adjusts the respective positions of the motor and the bearing using the wedge mount;

d) he/she fixes the bearing to the window;

e) he/she removes the wedge mount from the bearing and the motor;

f) he/she disposes of the wedge mount or returns it to the assembly circuit.

The drawback of this solution is the considerable cost of the wedge mount that can only be used once, as well as of the logistics involved if the wedge mount is used several times.

The invention solves this problem and, in order to do so, it provides a device for driving a motor vehicle windscreen-wiper arm, comprising a first motive part solidly attached to a support piece fixed to the body of the vehicle, driving a second part comprising a drive shaft for driving the windscreen-wiper arm, this second part being fixed to a bearing solidly attached to an element which is mobile in relation to the body, in particular a rear window, this device being associated with a mounting part, known as a wedge mount, temporarily linking said first and second parts so as to ensure the correct relative position of said parts, characterized in that said wedge mount is solidly attached to said first part or said second part by means of breakable tongue elements.

The invention does away with the operations of removing the wedge, returning it and managing it in the assembly circuit. This results in time saved during the assembly of the windscreen wiper.

The volume of the wedge mount is considerably reduced and so, therefore, is its cost.

According to a preferred embodiment of the invention, said first part comprises a motor, the shaft of which drives the rotation of a plate, the motor and the plate being solidly attached to said support piece, said plate being designed to drive a ratchet finger of a crank driving a drive shaft of the windscreen-wiper arm comprised in said second part, said wedge mount being solidly attached to said plate or said crank by means of said breakable tongue elements.

According to a first alternative embodiment, the wedge mount is formed integral with the plate during the moulding operation of the latter.

The wedge mount preferably consists of a tubular element coaxial to the plate and connected to it by said breakable tongue elements.

This tubular element also has an aesthetic function as it can conceal elements of the wiping system such as, for example, the plate nut or the shaft.

The wedge mount advantageously comprises, at its free end, interlocking and locking parts for said crank arm.

According to a second alternative embodiment, the wedge mount is a separate piece and it comprises at least two parts connected by said breakable tongue elements.

The first of said parts preferably comprises two parallel rails facing each other and receiving the longitudinal edges of the crank arm

Said first part can also comprise a central hemisphere designed for self-aligning by snap-fitting on the end of the drive shaft.

This improvement of the positioning between the bearing and the motor enables gains in terms of dimension transfers

The second of said parts advantageously consists of a tubular element coaxial to the drive shaft of the windscreen-wiper arm, comprising means for locking its rotation in relation to the plate and equipped with means for hooking axial to the plate.

Said wedge mount can also comprise a third part extending said first part by means of breakable tongue elements and comprising an interlocking orifice tightened on a tenon arranged on the bearing of said second part.

According to a third alternative embodiment, said wedge mount is associated with an additional piece supporting the crank arm and connected to the bearing by a breakable tongue element.

The invention is described in more detail below in reference to figures which only show preferred embodiments of the invention.

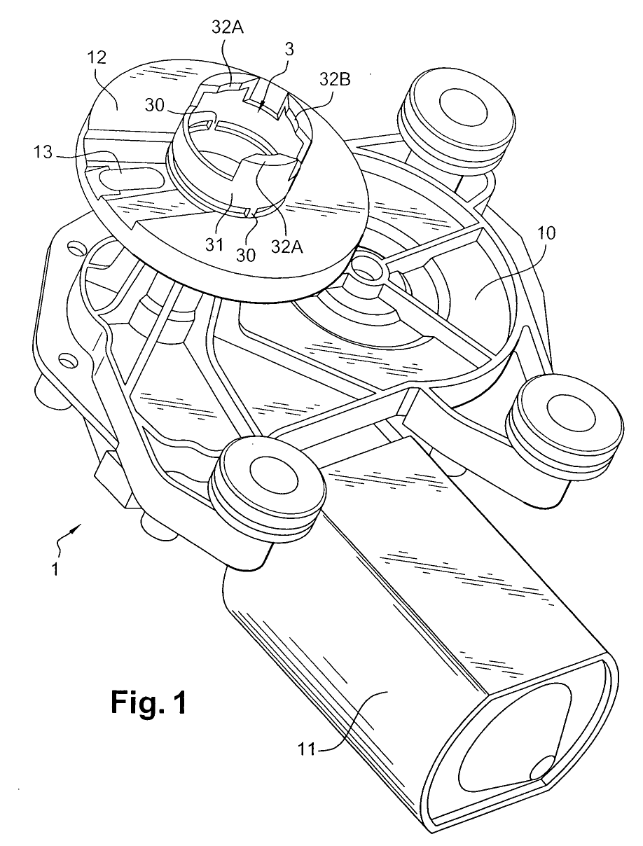

FIG. 1 is a perspective view of the first motive part solidly attached to a support piece fixed to the body of the vehicle according to a first alternative embodiment of the invention.

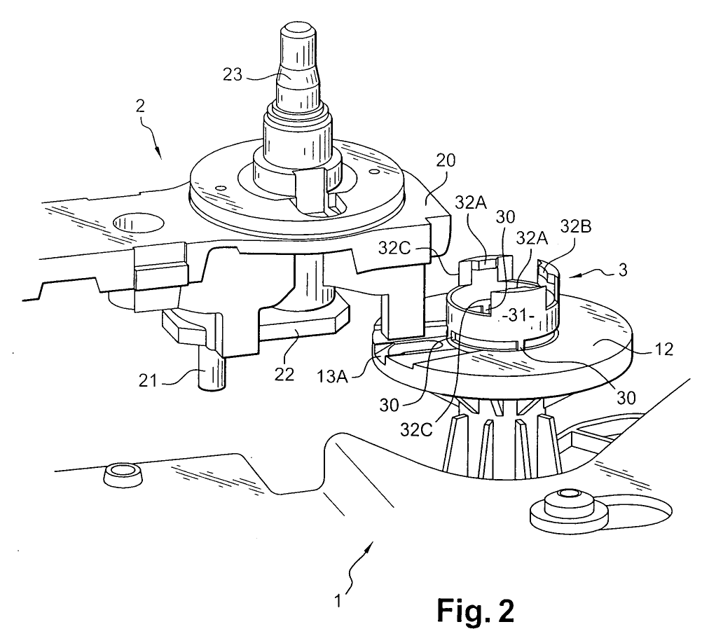

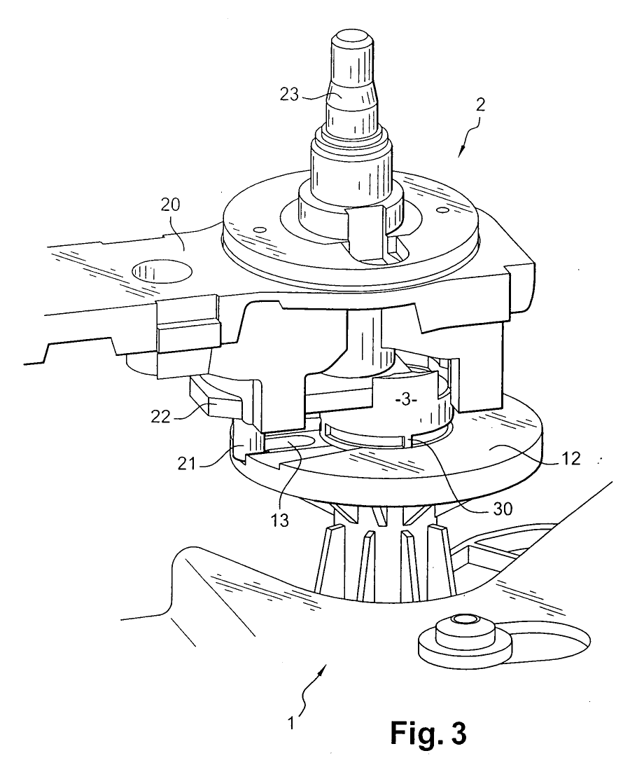

FIGS. 2 to 4 show perspective views depicting the assembly of a second part fixed to a bearing designed to be solidly attached to an element which is mobile in relation to the body, in particular a rear window, according to the same alternative embodiment of the invention.

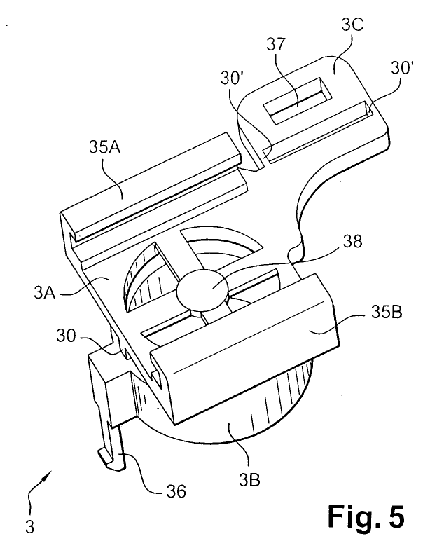

FIG. 5 is a perspective view of a wedge mount according to a second alternative embodiment of the invention.

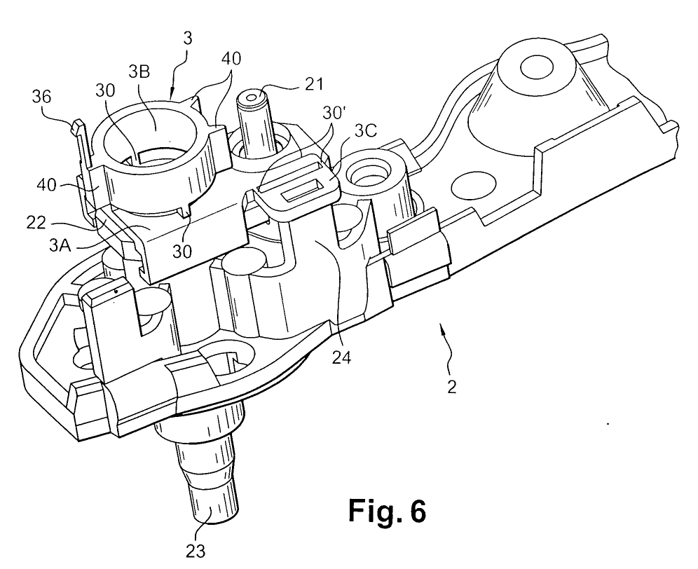

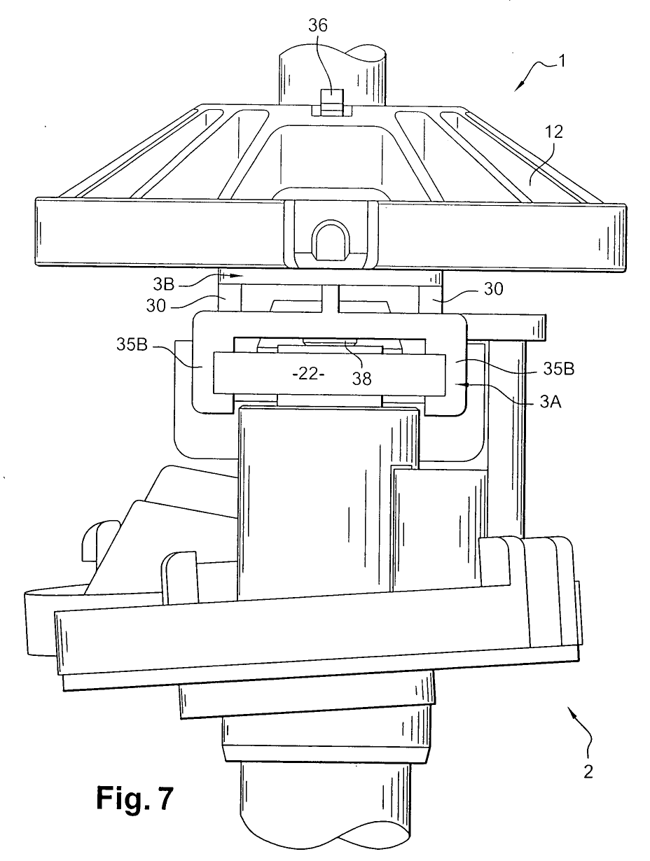

FIGS. 6 to 7 show perspective views depicting the assembly of a second part fixed to a bearing designed to be solidly attached to an element which is mobile in relation to the body, in particular a rear window, according to the same alternative embodiment of the invention.

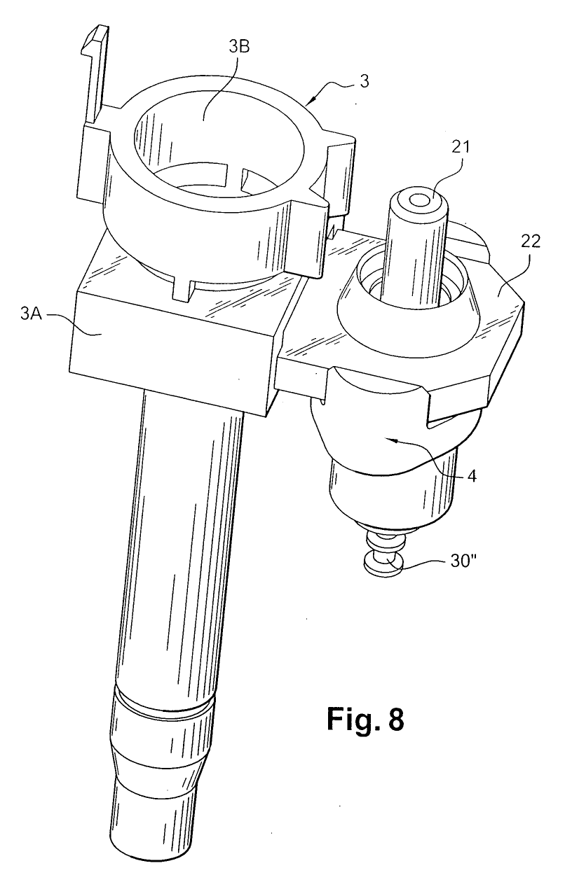

FIG. 8 is a perspective view of a wedge mount according to a third alternative embodiment of the invention.

According to the invention, the device for driving a windscreen-wiper arm of a motor vehicle comprises a first motive part 1 solidly attached to a support piece 10 fixed to the body of the vehicle, driving a second part 2 comprising a drive shaft 23 for driving the windscreen-wiper arm. This second part 2 being fixed to a bearing 20 solidly attached to an element which is mobile in relation to the body, in particular a rear window.

This device is associated with a mounting part, known as a wedge mount 3, which temporarily links the first and second parts 1, 2 so as to ensure the correct relative positioning of these parts and is solidly attached to the first part 1 or said second part 2 by means of breakable tongue elements. The mounting part 3 is mounted coaxially to the drive shaft 23 and can consist of a tubular element 31, coaxial to a plate 12.

The first part 1 comprises a motor 11, the shaft of which drives the rotation of the plate 12, equipped with an oblong hole 13, the motor and the plate being solidly attached to the support piece 10 and the plate 12 being designed to drive a ratchet finger 21 of a crank 22 driving the drive shaft 23 of the windscreen-wiper arm contained in said second part 2. This ratchet finger 21 is designed to be received in the oblong hole 13 of the plate 12.

FIG. 1 shows a first alternative embodiment of the invention.

The wedge mount 3 is formed integral with the plate 12 during the moulding operation of the latter and is solidly attached to the plate by means of breakable tongue elements 30. The wedge mount 3 consists of a tubular element 31 coaxial to the plate 12 and connected to it by the breakable tongue elements 30. It comprises interlocking and locking parts 32 for the crank 22 of the second part 2 of the device at its free end.

The second part 2 of the device is mounted radially in the wedge mount 3 as shown in FIGS. 2 to 4.

The crank arm 22 is received between two interlocking and locking parts 32A. The crank arm 22 advantageously comprises two side notches, not shown, cooperating with the lateral edge 32C of the interlocking and locking parts, so as to ensure the snap-fitting of the crank arm. Furthermore, these interlocking and locking parts 32A each comprise a stopping rib ensuring the interlocking of the crank arm 22 in a direction parallel to the plate shaft. The crank arm 22, when fully mounted, comes to a stop against a third interlocking part 32B which is also equipped with a support rib. Thus the crank arm 22 is locked in relation to the plate 12 in a plane parallel to it and perpendicular to the drive shaft.

During assembly, the ratchet finger 21 is inserted in the oblong hole 13 of the plate by means of a tilted plane 13A arranged at its radial entrance. Alternatively, the oblong hole 13 can be open radially.

In the case of a device with a module comprising the motor 11 and a lock, not shown, the link between the strike and the lock provides an additional linking point between the two parts 1, 2.

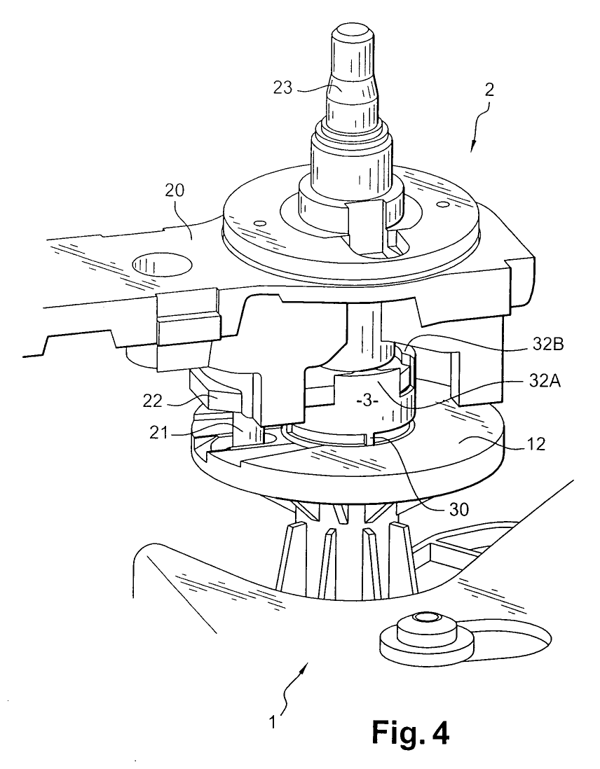

Once the system is mounted on the vehicle as shown in FIG. 4, the breakable tongue elements 30 are broken, either by axial stress, for example by opening the window, or by rotational stress, for example when the motor is powered for the first time. The wedge mount 3 is then separated from the plate 12 and can remain permanently connected to the crank 22 or be removed.

FIG. 5 shows a second alternative embodiment of the invention.

The wedge mount 3 is a separate piece and comprises three parts 3A, 3B, 3C connected by breakable tongue elements 30, 30′.

A first part 3A is interlocked on the crank arm 22 of the second part 2 of the device. For this reason, it comprises two parallel rails 35A, 35B facing each other and receiving the longitudinal edges of the crank arm 22. This first part 3A also comprises a central hemisphere 38 designed for self-aligning by snap-fitting on the end of the drive shaft supported by the first part 1 of the device.

A second part 3B consists of a tubular element coaxial to the drive shaft of the windscreen-wiper arm and comprising three peripheral axial ribs 40 which block the rotation of the plate in a position that ensures the synchronism of the two parts 1, 2 of the device. This tubular element is also equipped with at least one means for hooking axial to the plate 12. This means consists of a finger 36 parallel to the drive shaft of the windscreen-wiper arm and comprising an interlocking ratchet at its end designed to come to a stop against the face of the plate 12, opposite the second part 2 of the device. This finger provides temporary support for the first and second parts 1, 2 prior to assembly on the vehicle, and then supports the part 3B of the wedge mount with the plate 12, when the breakable tongue elements 30 are broken.

A third part 3C extends the first part 3A and comprises 10 an interlocking orifice 37 tightened on a tenon 24 arranged on the bearing 20 of the second part 2 of the device.

In a first alternative assembly, by adding a chamfer to the third part 3C of the wedge mount, it can be mounted on the tenon 24, during the translation of the crank arm 22 in the rails 35A of the second part 3B of the wedge mount, and by simply pressing on this part, it is tightly interlocked on the tenon 24 of the bearing 20.

In a second alternative assembly, the wedge mount 3 is mounted on the crank arm 22 at the end of the shaft 23 of the windscreen-wiper arm and the shaft is then mounted on the bearing 20. The third part 3C of the wedge mount is then tightly mounted on the tenon 24 of the bearing 20. Then the assembly comprising the wedge mount and the second part 2 of the device is clipped onto the plate 12 of the first part 1 of the device.

Once the system is mounted on the vehicle as shown in FIG. 7, the breakable tongue elements 30, 30′ are broken, either by axial stress, for example by opening the window, or by rotational stress, for example when the motor is powered for the first time. The wedge mount 3 is then separated into three parts which can either remain in position permanently or be removed.

According to a third alternative embodiment shown in FIG. 8, the wedge mount comprises a first part 3A and a second part 3B identical to those of the previously described second alternative embodiment, but does not comprise a third part. Conversely, the wedge mount is associated with an additional piece locked on the crank arm 22 at the ratchet finger 21 and solidly attached to the bearing 20 by a breakable tongue element 30″. This piece is used to position the assembly correctly on the bearing and prevent it from losing its position during transport.

1. A device for driving a motor vehicle windscreen-wiper arm, comprising a first part solidly attached to a support piece fixed to the body of the vehicle, driving a second part comprising a drive shaft for driving the windscreen-wiper am, this second part being fixed to a bearing which is solidly attached to an element which is mobile in relation to the body, this driving device being associated with a mounting part temporarily linking said first and second parts so as to ensure the correct relative position of said parts, the temporary link being breakable, wherein the mounting part is mounted coaxially on the drive shaft.

2. The driving device according to claim 1, wherein the temporary link is a wedge mount comprising breakable tongue elements.

3. The device according to claim 2, wherein said first part comprises a motor, the shaft of which drives the rotation of a plate, the motor and the plate being solidly attached to said support piece, said plate being designed to drive a ratchet finger of a crank driving the drive shaft of the windscreen-wiper arm contained in said second part, and in that said wedge mount is solidly attached to said plate or said crank by means of said breakable tongue elements.

4. The device according to claim 3, wherein the wedge mount is formed integral with the plate during the moulding operation of the latter.

5. The device according to claim 4, wherein the wedge mount consists of a tubular element coaxial to the plate and connected to it by said breakable tongue elements.

6. The device according to claim 5, wherein the wedge mount comprises interlocking and locking parts for said crank arm on its free end.

7. The device according to claim 3, wherein the wedge mount is a separate piece and comprises at least two parts connected by said breakable tongue elements.

8. The device according to claim 7, wherein the first of said parts comprises two parallel rails facing each other and receiving the longitudinal edges of the crank arm.

9. The device according to claim 8, wherein said first part also comprises a central hemisphere intended for self-aligning by snap-fitting on the end of the drive shaft.

10. The device according to claim 8, wherein the second of said parts consists of a tubular element coaxial to the drive shaft of the windscreen-wiper arm, comprising means for locking its rotation in relation to the plate and equipped with means for hooking axial to the plate.

11. The device according to claim 10, wherein said wedge mount comprises a third part extending said first part by means of breakable tongue elements and comprising an interlocking orifice tightened on a tenon arranged on the bearing of said second part.

12. The device according to claim 10, wherein said wedge mount is associated with an additional piece supporting the crank arm and connected to the bearing by a breakable tongue element.

13. The device according to claim 9, wherein the second of said parts consists of a tubular element coaxial to the drive shaft of the windscreen-wiper arm, comprising means for locking its rotation in relation to the plate and equipped with means for hooking axial to the plate.
